(19) United States
(12) Patent Application Publication
(10) Pub. No.: US 2015/0321538 A1
(43) Pub. Date: Nov. 12, 2015

(54) FAST COOLING SYSTEM IN CARS

(71) Applicant: Jun-Wei Su, Taichung City (TW)

(72) Inventor: Jun-Wei Su, Taichung City (TW)

(21) Appl. No.: 14/687,907

(22) Filed: Apr. 15, 2015

(30) Foreign Application Priority Data
May 9, 2014 (TW) 103116609

(51) Int. Cl. B60H 1/32

(52) U.S. Cl. CPC B60H 1/3205; B60H 1/3204

(57) ABSTRACT

A fast cooling system for a car includes an active or passive energy storage device, a temperature mixer and a control module. The energy storage device is located in the temperature mixer. The control module compares the temperatures of the energy storage device and an evaporator in the temperature mixer and the temperature in the car. Based on the result of the comparison, the control module controls the path of air that travels through the temperature mixer to guide the air flow to travel past the evaporator and/or the energy storage device. The air gets cool when it travels past the energy storage device in the form of a cold storage device. The cool air enters the car and rapidly reduces the temperature in the car.

### BACKGROUND OF INVENTION

1. Field of Invention

The present invention relates to air-conditioning in a car and, more particularly, to a fast cooling system in a car.

2. Related Prior Art

When a car is parked outdoors in the day, the temperature in the car rises fast and reaches as high as 70° C. due to the heat of the sun light, the thermal conductivity of the sheet-metal of the car, and poor convection in the car. People feel uncomfortable in the car at such high temperature. In an attempt to rapidly cool the cabin of the car, it is a common practice to open all of the windows of the car and turn on the air-conditioner of the car to provide the maximum nominal airflow at the lowest nominal temperature. However, the air conditioner does not immediately provide a high airflow at low temperature into the car because it takes time for the refrigerant compressor thereof to reach the highest power. In practice, it takes about 180 to 300 seconds to reduce the temperature in the car to a comfortable range of 20° C. to 25° C. from the uncomfortable range of 60° C. to 70° C. Obviously, a conventional air conditioner does not cool the cabin of the car fast enough.

To solve the above-mentioned problem, methods are used to shade the cabin of the car from the sun. For example, sheathing paper and visor curtains are used to prevent the temperature in the car from getting too high. However, the use of sheathing paper and visor curtains is not satisfactory in suppressing the rise of the temperature in the car.

Alternatively, a sprayer is used to spray refrigerant in the car. However, the use of the refrigerant is not satisfactory in cooling the cabin of the car. The refrigerant might release volatile gases that might impose risks to health.

Alternatively, a radiator is used to remove heat from the cabin of the car. However, the radiator consumes electricity in use. To prevent the battery of the car from running out of electricity, it would be better to power the radiator with an auxiliary power supply such as a photovoltaic device. It is difficult to make room for the radiator and the auxiliary power supply. It is inevitable to damage the sheet-metal of the car and change the look of the car in an attempt to attach the radiator and the auxiliary power supply to the car. It is troublesome to attach the radiator and the auxiliary power supply to the car. The radiator and the auxiliary power supply together add a lot of weight to the car. These downsides prevent users from using radiators for their cars.

The present invention is therefore intended to obviate or at least alleviate the problems encountered in prior art.

### SUMMARY OF INVENTION

It is an objective of the present invention to provide a car with a fast cooling system for rapidly reducing the temperature in the car to a comfortable range of 20° C. to 25° C. from an uncomfortable range of 60° C. to 70° C. in about 30 to 60 seconds.

To achieve the foregoing objective, the fast cooling system includes an active or passive energy storage device, a temperature mixer and a control module. The energy storage device is located in the temperature mixer. The control module compares the temperatures of the energy storage device and an evaporator in the temperature mixer and the temperature in the car. Based on the result of the comparison, the control module controls a path of air that travels through the temperature mixer to guide the air flow to travel past the evaporator and/or the energy storage device. The air gets cool when it travels past the energy storage device in the form of a cold storage device. The cool air enters the car and rapidly reduces the temperature in the car.

In another aspect, the temperature mixer includes an energy storage device channel for containing the energy storage device, and insulation linings are used in the energy storage device channel to keep the energy storage device in a coolness-storing status for a period of 18 to 48 hours.

Advantageously, the energy storage device is used in coordination with an air conditioner of the car that includes an evaporator or refrigerant pipe to cause the passive or active energy storage device to store energy in the form of coolness.

The passive energy storage device does not require an additional power supply. The active energy storage device is energized by the refrigerant compression system, which is powered by the power supply of the car. Generally speaking, the operation of the present invention does not require the use of an additional power supply.

The cool air provided by the energy storage device travels into the car to reduce the temperature in the car immediately after the car and the air conditioner are turned on. This helps reduce the temperature in the car after it is has been parked under the sun for a long period of time because the cool air immediately travels into the car from the energy storage device even in this situation.

The energy storage device in the coolness-storing status reduces the temperature in the car to the comfortable range of 20° C. to 25° C. from the uncomfortable range of 60° C. to 70° C. in about 30 to 60 seconds.

The fast cooling system rapidly reduces the temperature in the car after the air conditioner of the car is turned on. Then, the air conditioner takes over to keep the temperature in the car at the temperature set by the user.

The fast cooling system of the present invention reduces the burden on the air conditioner of the car when the air conditioner is just turned on. In the operation of the air conditioner equipped with the energy storage device of the present invention, the airflow can be set to low or medium since the temperature of the energy storage device is low, the temperature of the cool air provided from the energy storage device is low, and a low or medium airflow is enough to mix the cool air with the hot air in the car for efficient heat exchange. This does not bring a heavy burden on the generator of the car.

The energy storage device of the present invention is small, light, and compatible with temperature mixture systems provided by different car manufacturers. Simple control over the air doors is all it takes to use the energy storage device of the present invention with the air conditioner of the car. The installment and use of the energy storage device of the present invention with the air conditioner of the car are easy.

Other objectives, advantages and features of the present invention will be apparent from the following description referring to the attached drawings.

### BRIEF DESCRIPTION OF DRAWINGS

The present invention will be described through detailed description of two embodiments referring to the drawings wherein:

FIG. 1 is a perspective view of an energy storage device according to the first embodiment of the present invention;

FIG. 2 is a front view of the energy storage device shown in FIG. 1;

FIG. 3 is a side view of the energy storage device shown in FIG. 1;

FIG. 4 is a perspective view of a temperature mixer that includes the energy storage device shown in FIG. 1;

FIG. 5 is a cross-sectional view of the temperature mixer shown in FIG. 4;

FIG. 6 is a cross-sectional view of the temperature mixer of FIG. 5 illustrating an operational status of the temperature mixer;

FIG. 7 is a cross-sectional view of the temperature mixer of FIG. 5 illustrating another operational status of the temperature mixer;

FIG. 8 is a cross-sectional view of the temperature mixer of FIG. 5 illustrating yet another operational status of the temperature mixer;

FIG. 9 is a perspective view of an energy storage device according to the second embodiment of the present invention;

FIG. 10 is a cross-sectional view of the temperature mixer that includes the energy storage device shown in FIG. 9, illustrating an operational status of the temperature mixer;

FIG. 11 is a cross-sectional view of the temperature mixer that includes the energy storage device shown in FIG. 9, illustrating another operational status of the temperature mixer;

FIG. 12 is a cross-sectional view of the temperature mixer that includes the energy storage device shown in FIG. 9, illustrating yet another operational status of the temperature mixer;

FIG. 13 is a cross-sectional view of the temperature mixer that includes the energy storage device shown in FIG. 9, illustrating yet another operational status of the temperature mixer;

FIG. 14 is a cross-sectional view of the temperature mixer that includes the energy storage device shown in FIG. 9, illustrating yet another operational status of the temperature mixer; and

FIG. 15 is a simplified view of a car that includes the temperature mixer shown in FIG. 4.

### DETAILED DESCRIPTION OF EMBODIMENTS

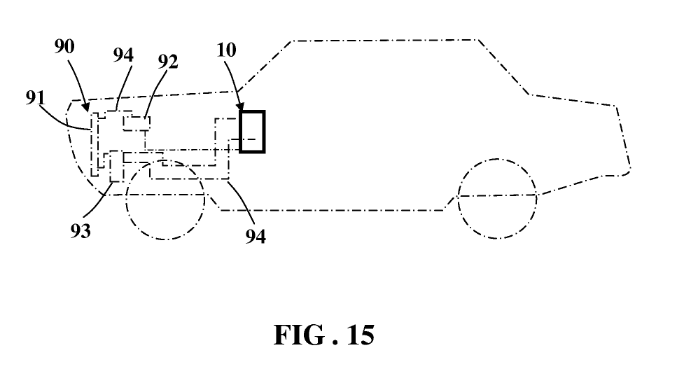

Referring to FIG. 15, a car (not numbered) includes an air conditioner (not numbered) that includes a refrigerant compression system 90. The refrigerant compression system 90 includes a condenser 91, a compressor 92, an expansion valve 93 and a refrigerant piping 94. The expansion valve 93 includes one inlet (not numbered) and two outlets (not numbered).

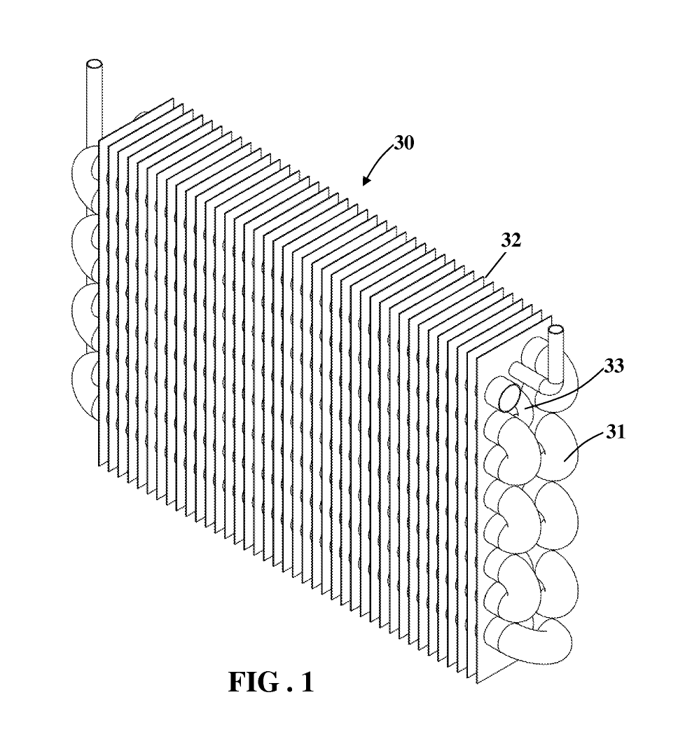

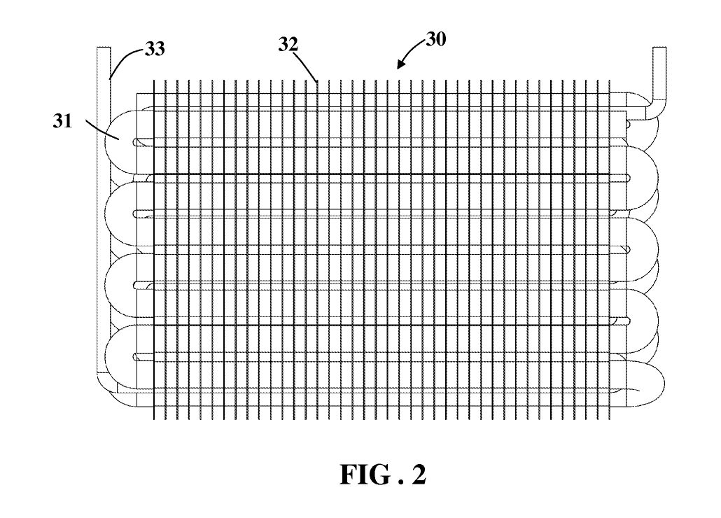

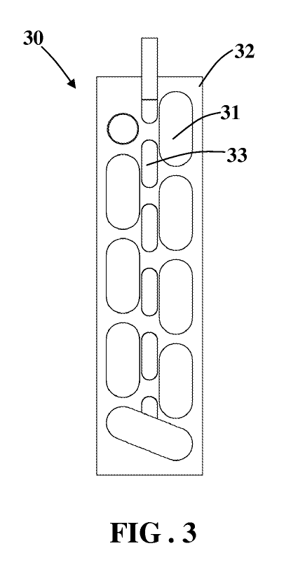

Referring to FIGS. 1 to 4 and 15, the car is further equipped with a fast cooling system according to a first embodiment of the present invention. The fast cooling system includes a temperature mixer (not numbered) that includes an active energy storage device 30. The active energy storage device 30 includes an energy storage pipe 31, radiators 32 and a refrigerant pipe 33. The radiators 32 are fins that extend parallel to one another. The radiators 32 can however be made in another proper configuration in another embodiment.

The energy storage pipe 31 extends through the radiators 32 in a multi-pass manner. The energy storage pipe 31 is a closed metal pipe filled with an energy storage material. The energy storage pipe 31 is made of aluminum, copper, stainless steel or any other proper metal. The energy storage material is a coolant material that includes, but not limited to, water, cryogen-containing liquid, ionized liquid, a mixture of water with carbon nanotubes, or a mixture of water with a metal oxide. The coolness storage material is characterized in that it is switched into a coolness-storing status (such as frozen) from a normal status (such as liquid) at low temperature (such as 0° C. to 10° C.) and that it is switched back into the normal status from the coolness-storing status at high temperature because of heat exchange. The switch between the coolness-storing status and the normal status can be repeated for many times.

The radiators 32 and the energy storage pipe 31 are formed in one piece, or made separately and then joined together. The radiators 32 are used to enhance the heat exchange of the energy storage pipe 31.

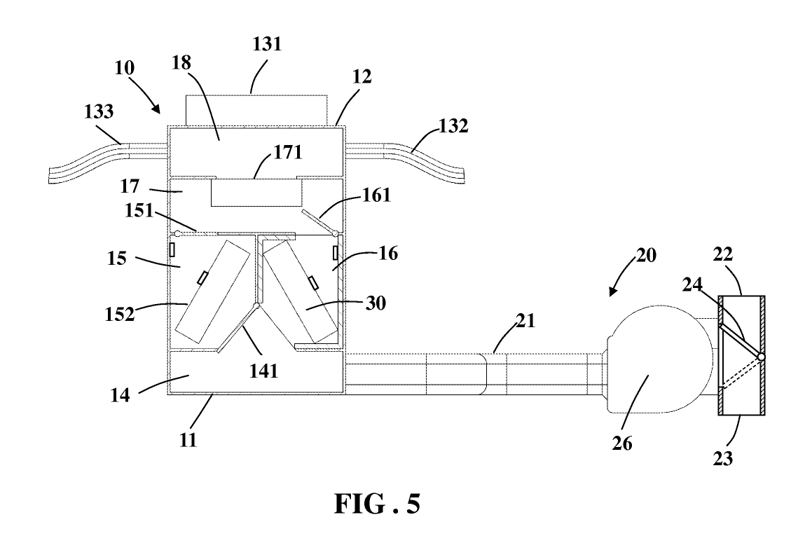

The refrigerant pipe 33 also extends through the radiators 32 in a multi-pass manner. In operation, the refrigerant pipe 33 is connected to an evaporator 152 (FIG. 5) of the compressor 92 of the refrigerant compression system 90 of a car.

Because the refrigerant pipe 33 is connected to the evaporator 152, the active energy storage device 30 can be cooled by the air conditioner of the car. Thus, the coolness storage material can be switched into the coolness-storing status from the normal status. To connect the refrigerant pipe 33 to the evaporator 152, an auxiliary expansion valve is used in addition to an original expansion valve, or the original expansion valve, which includes one inlet and one outlet, is replaced with the expansion valve 93, which includes one inlet and two outlets.

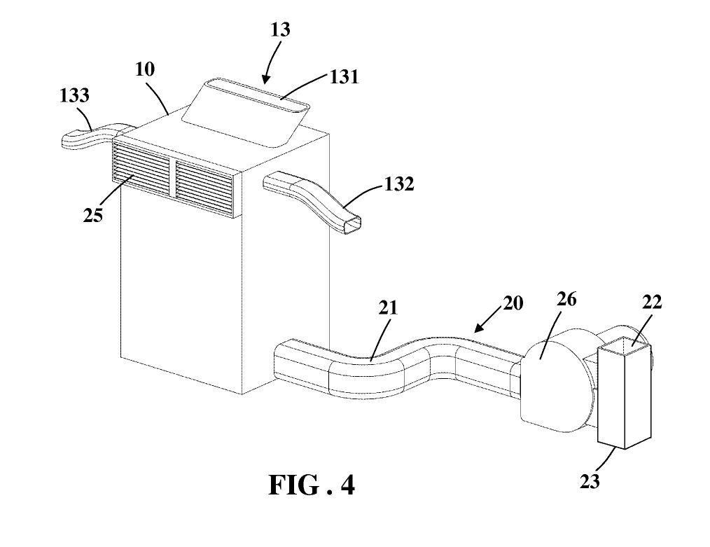

Referring to FIG. 4, the temperature mixer includes a box 10 and an air inlet device 20. The box 10 includes two opposite ends 11 and 12. The air inlet device 20 is connected to the first end 11 of the box 10.

The box 10 includes an air outlet device (not numbered) including an air distributor 13 and an air vent 25. The air distributor 13 includes a demister pipe 131, a shotgun seat pipe 132 and a driver's seat pipe 133. The demister pipe 131 is connected to the second end 12 of the box 10. The shotgun seat pipe 132 is connected to a side of the box 10, near the second end 12. The driver's seat pipe 133 is connected to an opposite side of the box 10, near the second end 12. An air vent 25 is arranged on another side of the box 10, near the second end 12.

Referring to FIG. 5, the box 10 includes therein an air inlet channel 14, an evaporator channel 15, an energy storage device channel 16, a heater core channel 17 and a temperature-mixing channel 18. The air inlet channel 14 is disposed at the first end 11 of the box 10. The evaporator 152 is located in the evaporator channel 15. The active energy storage device 30 is located in the energy storage device channel 16. The refrigerant pipe 33 of the active energy storage device 30 can extend through walls of the box 10 in an air-tight manner.

An air door 141 is arranged amid the air inlet channel 14, the evaporator channel 15 and the energy storage device channel 16. The air door 141 is used to selectively communicate the air inlet channel 14 with the evaporator channel 15 or the energy storage device channel 16.

The heater core channel 17 is disposed above the evaporator channel 15 and the energy storage device channel 16. A heater core 171 is located in the heater core channel 17. Another air door 151 is arranged between the evaporator channel 15 and the heater core channel 17. Another air door 161 is arranged between the energy storage device channel 16 and the heater core channel 17.

The temperature-mixing channel 18 is disposed at the second end of the box 10. The temperature-mixing channel 18 is in communication with the air distributor 13 and the air vent 25.

An insulation lining 71 is provided on a side of the air door 141 that faces the energy storage device channel 16. Another insulation lining 71 is provided on a side of the air door 161 that faces the energy storage device channel 16. At least one other insulation lining 71 is provided on an internal face of the energy storage device channel 16. The insulation linings 71 are made of a PE foam material for example. The insulation linings 71 are 2 to 5 centimeters thick, and respectively attached to the air doors 141 and 161 and the internal face of the energy storage device channel 16 by adhesive.

When the energy storage device channel 16 is shut by the air doors 141 and 161, the insulation linings 71 keep the active energy storage device 30 in the coolness-storing status for 18 to 48 hours. The period in which the coolness-storing status is kept depends on the material used to make the insulation linings 71.

The air inlet device 20 includes an air inlet pipe 21 and a blower 26. The blower 26 is arranged between a first end of the air inlet pipe 21 and a manifold (not numbered). A second end of the air inlet pipe 21 is connected to the air inlet channel 14. The manifold includes an external air inlet 22 and an internal air inlet 23. The internal air inlet 23 can be located in the car. An air door 24 is arranged between the external air inlet 22 and the internal air inlet 23. The air door 24 selectively opens one of the air inlets 22 and 23. The blower 26 drives air into the air inlet channel 14 from the external air inlet 22 or the internal air inlet 23 through the air inlet pipe 21.

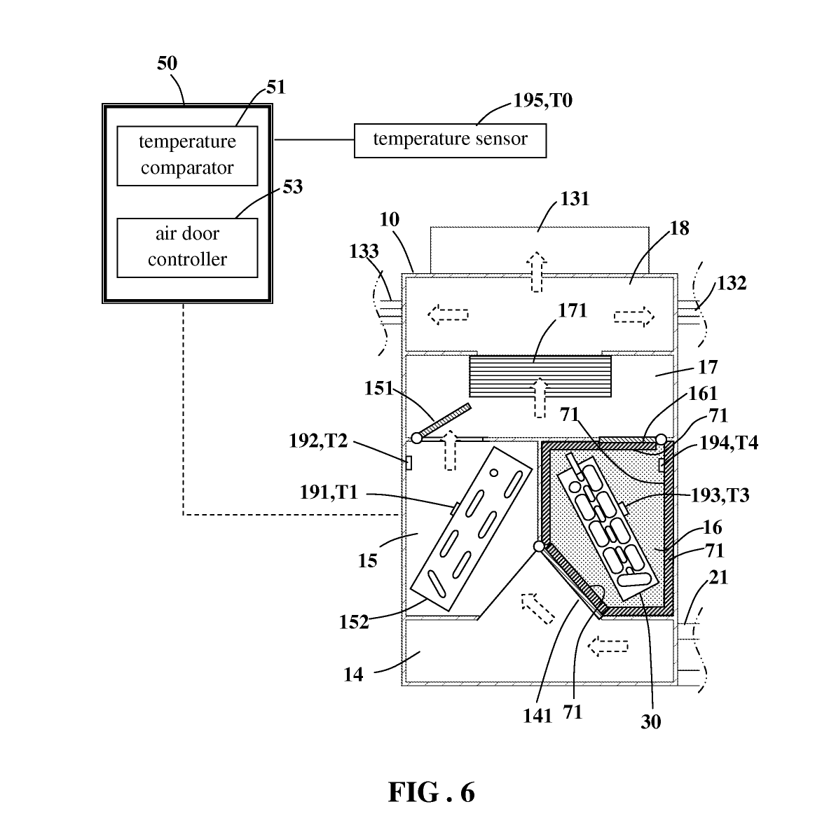

Referring to FIG. 6, temperature sensors 191, 192, 193, 194 and 195 are located in the evaporator 152, evaporator channel 15, the active energy storage device 30, the energy storage device channel 16 and the car, respectively. The temperature sensor 191 continuously measures the temperature T1 of the evaporator 152. The temperature sensor 192 continuously measures the temperature T2 of the evaporator channel 15. The temperature sensor 193 continuously measures the temperature T3 of the active energy storage device 30. The temperature sensor 194 continuously measures the temperature T4 of the energy storage device channel 16. The temperature sensor 195 continuously measures the temperature T0 of the car. Signals representative of the temperatures T1, T2, T3, T4 and T0 are sent to a control module 50.

The control module 50 includes a temperature comparator 51 and an air door controller 53. The temperature comparator 51 receives, processes, compares, and analyses the temperatures T1, T2, T3, T4 and T0 and a temperature Tt set by a user of the car. The temperature comparator 51 sends a control signal to the air door controller 53 according to the result of the analysis. The air door controller 53 controls the air doors 141, 151 and 161.

The operation of the fast cooling system will be described regarding several scenarios. In the first scenario, the fast cooling system is turned on the first time, or it is turned on again after it has been stopped for more than 18 to 48 depending on the material used to make the insulating linings 71. That is, the active energy storage device 30 is not in the coolness-storing status. The car and the refrigerant compression system 90 are turned on. The control module 50 controls the operation of the temperature mixer.

The temperature sensors 191, 192, 193, 194, 195 respectively send the temperatures T1, T2, T3, T4 and T0 to the temperature comparator 51. The temperature sensors 191, 192, 193, 194 and 195 continuously sense the temperatures in the operation of the car and the refrigerant compression system 90.

Then, the temperature comparator 51 compares the temperatures. If the temperature T0 in the car is higher than the temperature Tt set by the user, and temperature T3 of the active energy storage device 30 is higher than or equal to the temperature T1 of the evaporator 152 (T3≧T1), the temperature comparator 51 sends a control signal to the air door controller 53. According to the control signal, the air door controller 53 uses the air door 141 and the air door 161 to close the energy storage device channel 16, and open the air door 151. Thus, air travels into the car from the air vent 25 and the air distributor 13 via the air inlet channel 14, the evaporator channel 15, the heater core channel 17, the temperature-mixing channel 18, the air vent 25 and the air distributor 13. The refrigerant compression system 90 operates to reduce the temperature of the evaporator 152 and the temperature of the active energy storage device 30, which is equipped with the refrigerant pipe 33. That is, the temperature T2 of the air that travels through the evaporator channel 15 is reduced by the operation of the evaporator 152. In addition, the heater core 171 regulates the temperatures by using the cool air that travels into the car from the air vent 25 and the air distributor 13 to reduce the temperature T0 in the car to the temperature Tt set by the user. Due to the operation of the refrigerant piping 94 of the refrigerant compression system 90, the coolness storage material filled in the energy storage pipe 31 of the active energy storage device 30 is switched into the coolness-storing status from the normal status. That is, the active energy storage device 30 stores energy in the form of coolness.

When the car and the refrigerant compression system 90 operate, the air travels into the box 10 from the air inlet device 20, and then travels through the air inlet channel 14, the evaporator channel 15, the heater core channel 17 and the temperature-mixing channel 18, and then leaves the box 10. The air doors 141 and 161 continue to close the energy storage device channel 16.

When the user turns off the car and the refrigerant compression system 90, the air doors 141 and 161 continue to close the energy storage device channel 16, the insulation linings 71 continue to keep the active energy storage device 30 in the coolness-storing status for about 18 to 48 hours.

In the second scenario, the car and refrigerant compression system 90 are turned on within 18 to 48 hours after it was previously turned off, and the active energy storage device 30 is still in the coolness-storing status. The control module 50 controls the temperature mixer.

At first, the temperature sensors 191, 192, 193, 194, 195 respectively send the temperatures T1, T2, T3, T4 and T0 to the temperature comparator 51 of the control module 50. The temperature sensors 191, 192, 193, 194, 195 continuously sense the temperatures during the operation of the car and the refrigerant compression system 90.

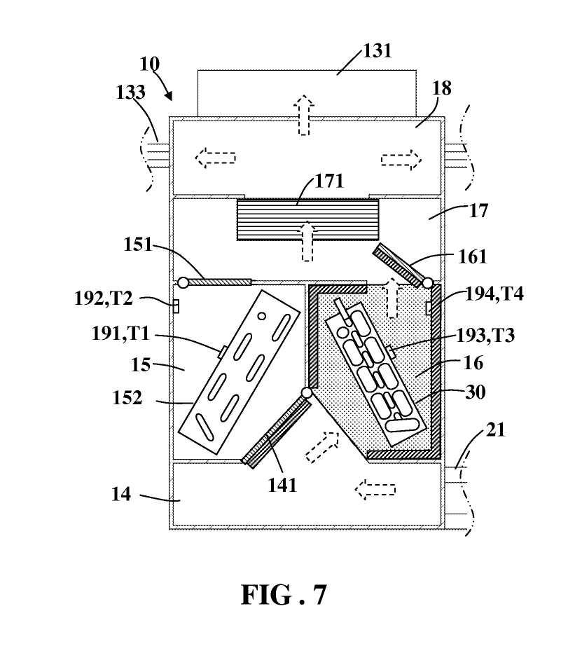

Then, referring to FIG. 7, the temperature comparator 51 compares the temperatures. If the temperature T0 in the car is higher than the temperature Tt set by the user (T0>Tt), and the temperature T3 of the active energy storage device 30 is lower than the temperature T1 of the evaporator 152 (T3<T1), the temperature comparator 51 sends a control signal to the air door controller 53, and the air door controller 53 uses the air doors 141 and 151 to close the evaporator channel 15, and opens the air door 161. Thus, the air from the air inlet device 20 travels through the air inlet channel 14, the energy storage device channel 16, the heater core channel 17, and the temperature-mixing channel 18. Finally, the air leaves the box 10 from the air vent 25 and the air distributor 13. Since the active energy storage device 30 is in the coolness-storing status, heat exchange occurs between the active energy storage device 30 and the air that flows past it, and the temperature of the air drops quickly. Thus, the air vent 25 and the air distributor 13 provide cool air. The cool air is mixed with hot air in the car, and the temperature T0 in the car is rapidly reduced. The cooling effected by the active energy storage device 30 reduces the temperature T0 in the car quickly even if the car has been parked under the sun and the temperature T0 in the car has reached 60° C. to 70° C. At the same time, the refrigerant piping 94 of the refrigerant compression system 90 reduces the temperature of the evaporator 152.

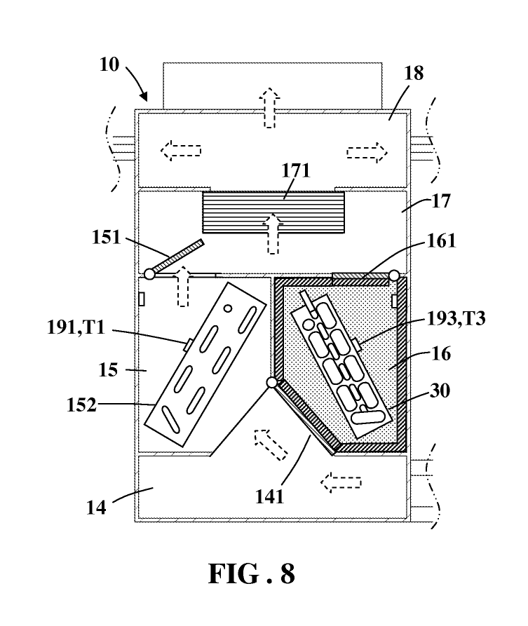

The cool air provided by the active energy storage device 30 rapidly reduces the temperature in the car. If the temperature comparator 51 determines that the temperature T0 in the car to is equal to the temperature Tt set by the user (T0=Tt), or the temperature T0 in the car has dropped to a considerable extent (20° C. to 40° C. for example), and the temperature T3 of the active energy storage device 30 becomes higher than the temperature T1 of the evaporator 152 (the heat exchange by the active energy storage device 30 is saturated), the temperature comparator 51 sends a control signal to the air door controller 53. Referring to FIG. 8, the air door controller 53 uses the air doors 141 and 161 to close the energy storage device channel 16, and opens the air door 151. Thus, the air from the air inlet device 20 travels through the air inlet channel 14, the evaporator channel 15, the heater core channel 17, and the temperature-mixing channel 18. Then, the air leaves the box 10 through the air vent 25 and the air distributor 13. Since the temperature of the evaporator 152 has dropped, heat exchange occurs between the evaporator 152 and the air that flows past it, and the temperature of the air drops. Then, the heater core channel 17 regulates the temperature to reach the temperature Tt set by the user. The air travels through the temperature-mixing channel 18 and then leaves the box 10 from the air distributor 13 and the air vent 25 to keep the temperature T0 in the car at the temperature Tt set by the user.

The air door controller 53 uses the air doors 141 and 161 to close the energy storage device channel 16, the coolness storage material filled in the energy storage pipe 31 of the active energy storage device 30 is switched into the coolness-storing status from the normal status because of the cooling provided by the refrigerant piping 94 of the refrigerant compression system 90. That is, the active energy storage device 30 stores coolness. Finally, the user turned off the car and the refrigerant compression system 90. Thus, the air doors 141 and 161 continue to close the energy storage device channel 16, and the insulation linings 71 continue to keep the active energy storage device 30 in the coolness-storing status for 18 to 48 hours.

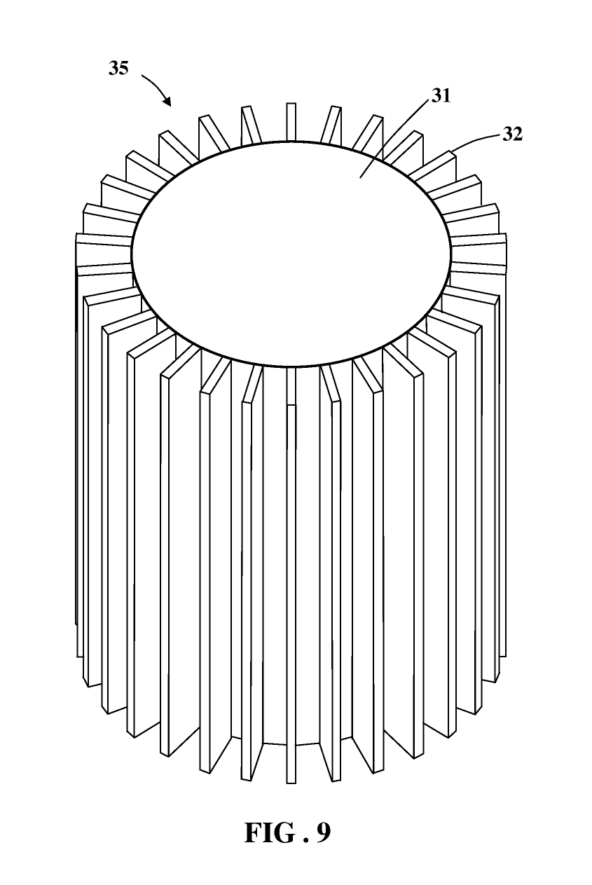

Referring to FIG. 9, a passive energy storage device 35 includes an energy storage pipe 31 and radiators 32 according to a second embodiment of the present invention. Preferably, the radiators 32 are fins extending from the energy storage pipe 31 in a radial manner. The radiators 32 can however be made in other configurations in other embodiments.

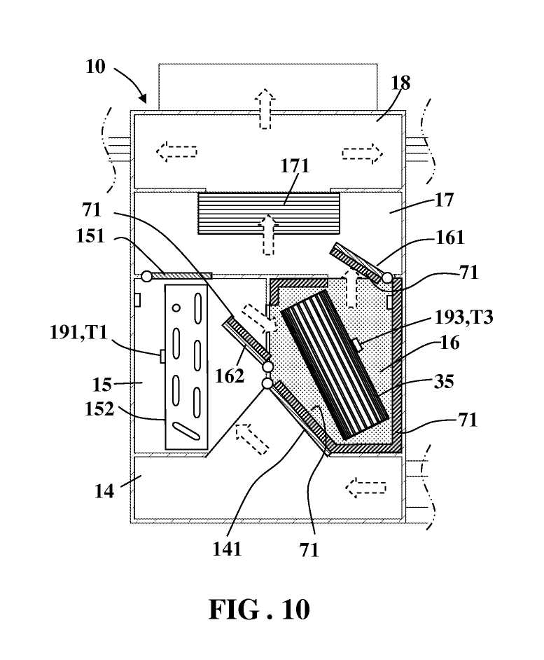

Referring to FIGS. 10 to 14, there is a temperature mixer according to the second embodiment of the present invention. The temperature mixer of the second embodiment is identical to the temperature mixer of the first embodiment except that it includes another door 162 arranged between the evaporator channel 15 and the energy storage device channel 16. Another insulation lining 71 is attached to a side of the air door 162 facing the energy storage device channel 16.

The operation of the temperature mixer under the control of the control module 50 will be described. In the third scenario, the fast cooling system of the car is parked for over 18 to 48 hours, dependent on the material used to make the insulation linings 71. That is, the passive energy storage device 35 is not in the coolness-storing status. The car and the refrigerant compression system 90 are turned.

Firstly, the temperature sensors 191, 192, 193, 194 and 195 send the temperatures T1, T2, T3, T4 and T0 to the temperature comparator 51 of the control module 50, respectively. The temperature sensors 191, 192, 193, 194, 195 continuously sense the temperatures during the operation of the car and the refrigerant compression system 90.

Referring to FIG. 10, if the temperature comparator 51 determines that the temperature T0 in the car is higher than temperature Tt set by the user, and the temperature T3 of the energy storage device 35 is higher than or equal to the temperature T1 of the evaporator 152 (T3≧T1), the temperature comparator 51 sends a control signal to the air door controller 53. According to the control signal, the air door controller 53 uses the air door 141 to close the energy storage device channel 16, opens the air door 162, uses the air door 151 to close the evaporator channel 15, and opens the air door 161. The air from the air inlet pipe 21 travels through the air inlet channel 14, the evaporator channel 15, the energy storage device channel 16, the heater core channel 17, and the temperature-mixing channel 18, and travels into the car from the box 10 via the air vent 25 and the air distributor 13. The refrigerant compression system 90 reduces the temperature of the evaporator 152. The air that travels past the evaporator channel 15 becomes cool air because of heat exchange with the evaporator 152. That is, the temperature T2 is reduced. The energy storage device 35 is cooled and switched into the coolness-storing status by the cool air from the evaporator channel 15.

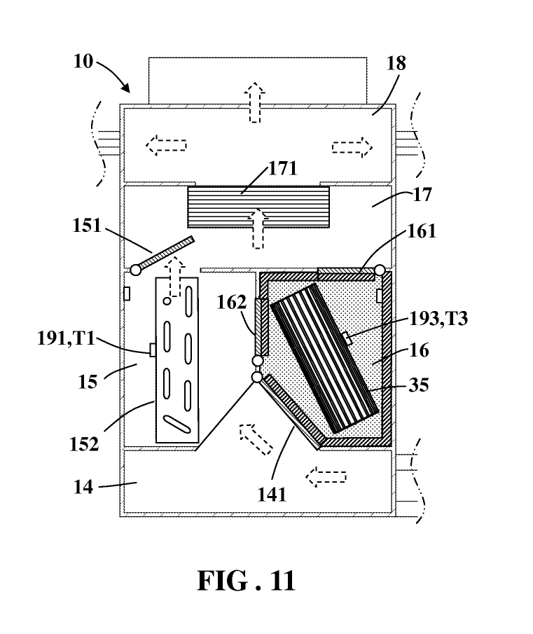

Referring to FIG. 11, if the temperature comparator 51 determines the temperature T3 of the energy storage device 35 to be equal to or lower than the temperature T1 of the evaporator 152 (T3≦T1), the temperature comparator 51 sends a control signal to the air door controller 53. According to the control signal, the air door controller 53 opens the air door 151, and uses the air doors 141, 162 and 161 to close the energy storage device channel 16. The insulation linings 71 cause the energy storage device channel 16 to keep the passive energy storage device 35 in the coolness-storing status for 18 to 48 hours. The air from the air inlet pipe 21 travels through the air inlet channel 14, the evaporator channel 15, the heater core channel 17 and the temperature-mixing channel 18. Then, the air travels into the car from the box 10 through the air vent 25 and the air distributor 13 to keep the temperature T0 in the car at the temperature Tt set by the user (T0=Tt).

When the user turns off the car and the refrigerant compression system 90, the air doors 141, 161 and 162 continue to close the energy storage device channel 16. The insulation linings 71 keep the energy storage device 35 in the coolness-storing status for 18 to 48 hours.

In the fourth scenario, the car is parked for less than 18 to 48 hours so that the energy storage device 35 is still in the coolness-storing status. When the car and the refrigerant compression system 90 are turned on again, the control module 50 controls the operation of the temperature mixer.

Firstly, the temperature sensors 191, 192, 193, 194 and 195 send the temperatures T1, T2, T3, T4 and T0, respectively, to the temperature comparator 51 of the control module 50. The temperature sensors 191, 192, 193, 194 and 195 continuously sense the temperatures during the operation of the car and the refrigerant compression system 90.

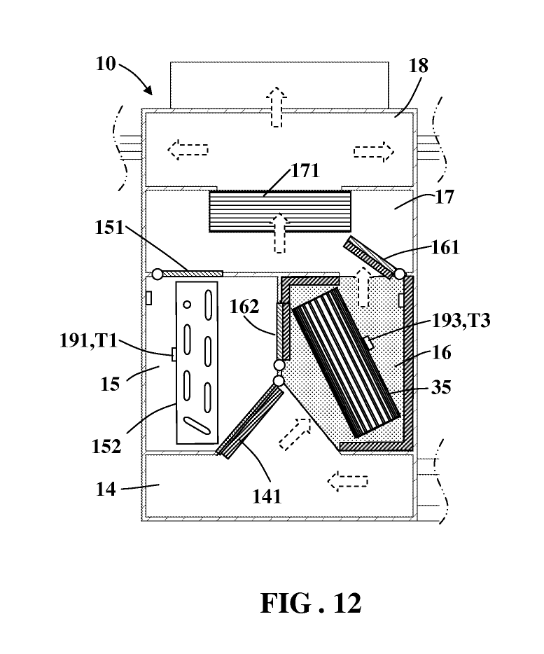

Referring to FIG. 12, if the temperature comparator 51 determines that the temperature T0 in the car is higher than the temperature Tt set by the user, and the temperature T3 of the passive energy storage device 35 is lower than the temperature T1 of the evaporator 152 (T3<T1), the temperature comparator 51 sends a control signal to the air door controller 53. According to the control signal, the air door controller 53 uses the air doors 141 and 151 to close the evaporator channel 15, closes the air door 162, and opens the air door 161. The air from the air inlet device 20 travels through the air inlet channel 14, the energy storage device channel 16, the heater core channel 17 and the temperature-mixing channel 18, and leaves the box 10 through the air vent 25 and the air distributor 13. Since the passive energy storage device 35 is in the coolness-storing status, heat exchange occurs between the energy storage device 35 and the air that travels past it. Thus, the air is rapidly turned into cool air. The cool air travels into the car from the box 10 through the air vent 25 and the air distributor 13. The cool air is mixed with hot air in the car to rapidly reduce the temperature T0 in the car. The cooling effected by the passive energy storage device 35 reduces the temperature T0 in the car quickly even if the car has been parked under the sun and the temperature T0 in the car has reached 60° C. to 70° C. At the same time, the refrigerant piping 94 of the refrigerant compression system 90 reduces the temperature of the evaporator 152.

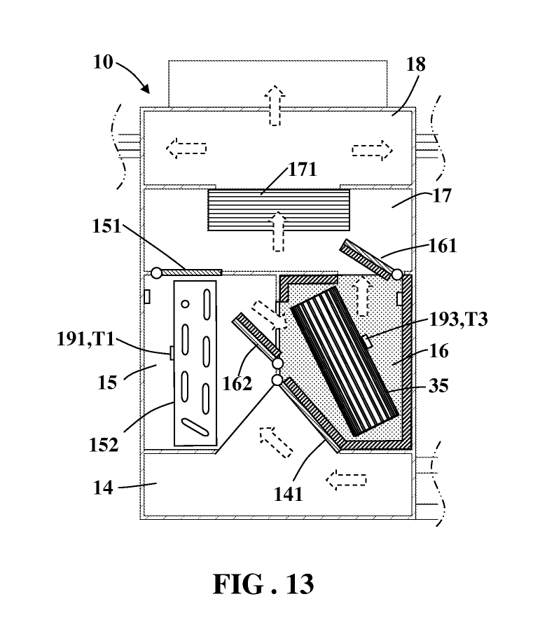

If the temperature comparator 51 determines that the temperature T0 in the car is equal to the temperature Tt set by the user (T0=Tt), or the temperature T0 in the car has dropped to a considerable extent (20° C. to 40° C. for example), and the temperature T3 of the passive energy storage device 35 becomes higher than the temperature T1 of the evaporator 152 (the heat exchange by the passive energy storage device 35 is saturated), the temperature comparator 51 sends a control signal to the air door controller 53. Referring to FIG. 13, the air door controller 53 uses the air door 141 to close the energy storage device channel 16, and opens the air door 162. Thus, the air from the air inlet pipe 21 travels through the air inlet channel 14, the evaporator channel 15, the energy storage device channel 16, the heater core channel 17, and the temperature-mixing channel 18. Then, the air travels into the car from the box 10 through the air vent 25 and the air distributor 13. As the temperature of the evaporator 152 drops, the evaporator 152 cools and turns the air, which travels through the evaporator channel 15, into cool air. The coolness storage material filled in the passive energy storage device 35 is cooled by the cool air that leaves the evaporator channel 15 and turned into the coolness-storing status from the status of saturated heat exchange.

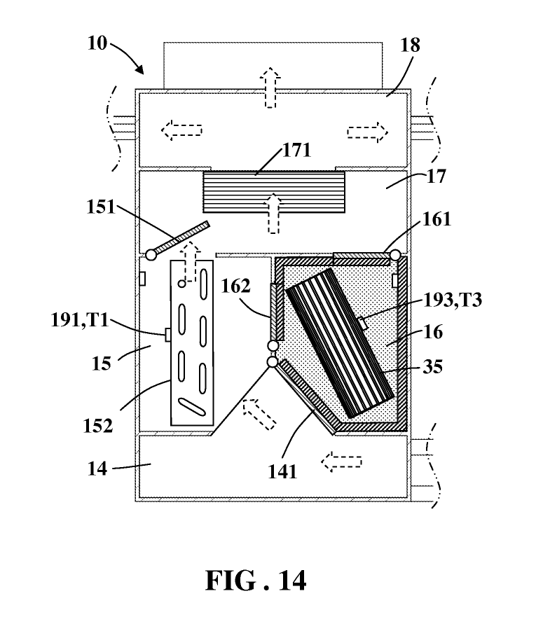

If the temperature comparator 51 determines the temperature T3 of the energy storage device 35 to be lower than the temperature T1 of the evaporator 152 (T3<T1), the temperature comparator 51 sends a control signal to the air door controller 53. As shown in FIG. 14, the air door controller 53 uses the air doors 141, 161 and 162 to close the energy storage device channel 16. The insulation linings 71 cause the energy storage device channel 16 to keep the passive energy storage device 35 in the coolness-storing status for 18 to 48 hours. The air from the air inlet pipe 21 travels through the air inlet channel 14, the evaporator channel 15, the heater core channel 17, and the temperature-mixing channel 18, and then travels into the car from the box 10 via the air vent 25 and the air distributor 13 to keep the temperature T0 in the car at the temperature Tt set by the user (T0=Tt).

As discussed above, the present invention exhibits some advantages over the prior art. The passive energy storage device 35 does not require an additional power supply. The active energy storage device 30 is energized by the refrigerant compression system 90, which is powered by the power supply of the car. Generally speaking, the operation of the present invention does not require the use of an additional power suppl.

The cool air provided by the energy storage device travels into the car to reduce the temperature in the car immediately after the car and the air conditioner are turned on. This helps reduce the temperature in the car after it has been parked under the sun for a long period of time because the cool air immediately travels into the car from the energy storage device even in this situation. The temperature in the car can be reduced to a comfortable range of 20° C. to 25° C. from an uncomfortable range of 60° C. to 70° C. in about 30 to 60 seconds.

It takes a conventional air conditioner about 180 to 300 seconds to the comfortable range of 20° C. to 25° C. from the uncomfortable range of 60° C. to 70° C. In the beginning of this period of 180 to 300 seconds, people are forced to endure the heat in the car. This problem with the prior art is solved by the fast cooling system of the present invention that rapidly reduces the temperature in the car after the air conditioner is turned on. The fast cooling system uses the energy storage device 30 or 35 to provide and mix the cool air with the hot air in the car. Thus, rapid heat exchange occurs between the cool air and the hot air in the car, and the temperature in the car rapidly drops. Then, the air conditioner takes over to keep the temperature in the car at the temperature set by the user.

In the operation of the conventional air conditioner, the airflow must be set to high and the temperature must be set to low when the air conditioner is just turned on. However, such setting brings a heavy burden onto the generator of the car, which is used to energize the air conditioner. The present invention reduces the burden on the air conditioner of the car when the air conditioner is just turned on. In the operation of the air conditioner equipped with the energy storage device of the present invention, the airflow can be set to low or medium since the temperature of the energy storage device is low, the temperature of the cool air provided from the energy storage device is low, and a low or medium airflow is enough to mix the cool air with the hot air in the car for efficient heat exchange. This does not bring a heavy burden on the generator of the car.

The energy storage device of the present invention is small, light, and compatible with temperature mixture systems provided by different car manufacturers. Simple control over the air doors is all it takes to use the energy storage device of the present invention with the air conditioner of the car. The installment and use of the energy storage device of the present invention with the air conditioner of the car are easy.

The present invention has been described via the detailed illustration of the embodiments. Those skilled in the art can derive variations from the embodiments without departing from the scope of the present invention. Therefore, the embodiments shall not limit the scope of the present invention defined in the claims.

1. A fast cooling system for use in a car, the fast cooling system including:
a box 10 including:
a first end 11 connected to an air inlet device 20;
a second end 12 opposite to the first end 11;
an air inlet channel 14 disposed in the first end 11 of the box 10 and connected to the air inlet device 20;
an air outlet device disposed in the vicinity of the second end 12 of the box 10;
an evaporator channel 15 for containing an evaporator 152 of a refrigerant compression system 90 of a car, wherein the evaporator channel 15 is in communication with the air inlet channel 14;
an energy storage device channel 16 for containing at least one energy storage device 30, wherein the energy storage device channel 16 is in communication with the air inlet channel 14;
a heater core channel 17 for containing at least one heater core 171, wherein the heater core channel 17 is in communication with the energy storage device channel 16 and the evaporator channel 15;
a temperature-mixing channel 18 in communication with the heater core channel 17 and the air outlet device;
a first air door 141 arranged amid the air inlet channel 14, the evaporator channel 15 and the energy storage device channel 16, and operable to selectively open one of the evaporator channel 15 and the energy storage device channel 16;
a second air door 151 arranged between the evaporator channel 15 and the heater core channel 17;
a third air door 161 arranged between the energy storage device channel 16 and the heater core channel 17; and
insulation linings 71 respectively attached to an internal face of the energy storage device channel 16, a side of the first air door 141 facing the energy storage device channel 16, and a side of the third air door 161 facing the energy storage device channel 16;
temperature sensors 191, 193, 195 respectively located at the evaporator 152 and the energy storage device 30, and in the car to sense the temperatures of the evaporator 152, the energy storage device 30 and the car; and
a control module 50 electrically connected to the temperature sensors and operatively connected to the first, second and third air doors, wherein the control module 50 receives, processes, compares and analyzes the temperatures from the temperature sensors and a temperature set by a user, and accordingly provides a control signal to control the first, second and third air doors.

2. The fast cooling system according to claim 1, wherein the energy storage device 30 includes:
at least one energy storage pipe 31 made of metal, having two closed ends, and filled with a coolness storage material; and
at least one refrigerant pipe 33 provided on and in direct contact with the energy storage pipe 31 and connected to the evaporator 152 of the refrigerant compression system 90 to reduce the temperature of the energy storage pipe 31.

3. The fast cooling system according to claim 2, wherein the energy storage device 30 further includes radiators 32 provided on the energy storage pipe 31 and the refrigerant pipe 33.

4. A control process executed in the fast cooling system according to claim 1, the control process including the steps of:
turning on the car and an air conditioner of the car;
using the control module 50 to compare the temperatures from the temperature sensors; and
if the temperature of the car is higher than the temperature set by the user and the temperature of the energy storage device 30 is higher than or equal to the temperature of the evaporator 152, using the first and third air doors to close the energy storage device channel 16, and opening the second air door, to guide air into the car through the air outlet device via the air inlet channel 14, the evaporator channel 15, the heater core channel 17 and the temperature-mixing channel 18, wherein the temperature of the energy storage device 30 in the closed energy storage device channel 16 is being reduced because of the refrigerant pipe 33.

5. The control process according to claim 4, further including the step of using the first and third air doors to close the energy storage device channel 16 when the car and the air conditioner are turned off.

6. A control process executed in the fast cooling system according to claim 1, the control process including the steps of:
turning on the car and an air conditioner of the car;
using the control module to compare the temperatures from the temperature sensors;
if the temperature of the car is higher than the temperature set by the user and the temperature of the energy storage device is lower than the temperature of the evaporator, using the first and second air doors to close the evaporator channel, and opening the third air door, to guide air into the car through the air outlet device via the air inlet channel, the energy storage device channel, the heater core channel and the temperature-mixing channel; and
if the temperature of the energy storage device is higher than the temperature of the evaporator, using the first and third air doors to close the energy storage device channel, and opening the second air door, to guide air into the car through the air outlet device via the air inlet channel, the evaporator channel, the heater core channel, the temperature-mixing channel, and the air outlet device, wherein the temperature of the energy storage device 30 in the closed energy storage device channel 16 is being reduced because of the refrigerant pipe 33.

7. The control process according to claim 6, further including the step of using the first and third air doors to close the energy storage device channel 16 when the car and the air conditioner are turned off.

8. A fast cooling system for use in a car, the fast cooling system including:
a box 10 including:
a first end 11 connected to an air inlet device 20;
a second end 12 opposite to the first end 11;
an air inlet channel 14 disposed in the first end 11 of the box 10 and connected to the air inlet device 20;
an air outlet device disposed in the vicinity of the second end 12 of the box 10;
an evaporator channel 15 for containing an evaporator 152 of a refrigerant compression system 90 of a car, wherein the evaporator channel 15 is in communication with the air inlet channel 14;
an energy storage device channel 16 for containing at least one energy storage device 35, wherein the energy storage device channel 16 is in communication with the air inlet channel 14;
a heater core channel 17 for containing at least one heater core 171, wherein the heater core channel 17 is in communication with the energy storage device channel 16 and the evaporator channel 15;
a temperature-mixing channel 18 in communication with the heater core channel 17 and the air outlet device;
a first air door 141 arranged amid the air inlet channel 14, the evaporator channel 15 and the energy storage device channel 16, and operable to selectively open one of the evaporator channel 15 and the energy storage device channel 16;
a second air door 151 arranged between the evaporator channel 15 and the heater core channel 17;
a third air door 161 arranged between the energy storage device channel 16 and the heater core channel 17;
a fourth air door 162 arranged between energy storage device channel 16 and the evaporator channel 15; and
insulation linings 71 respectively attached to an internal face of the energy storage device channel 16, a side of the first air door 141 facing the energy storage device channel 16, a side of the third air door 161 facing the energy storage device channel 16, and a side of the fourth air door 162 facing the energy storage device channel 16;
temperature sensors 191, 193, 195 respectively located at the evaporator 152 and the energy storage device 35, and in the car to sense the temperatures of the evaporator 152, the energy storage device 35 and the car; and
a control module 50 electrically connected to the temperature sensors and operatively connected to the first, second, third and fourth air doors, wherein the control module 50 receives, processes, compares and analyzes the temperatures from the temperature sensors and a temperature set by a user, and accordingly provides a control signal to control the first, second, third and fourth air doors.

9. The fast cooling system according to claim 8, wherein the energy storage device 35 includes at least one energy storage pipe 31 made of metal, having two closed ends, and filled with a coolness storage material.

10. The fast cooling system according to claim 9, further including radiators 32 provided on the energy storage pipe 31.

11. A control process executed in the fast cooling system according to claim 8, the control process including the steps of:
turning on the car and an air conditioner of the car;
using the control module to compare the temperatures from the temperature sensors;
if the temperature of the car is higher than the temperature set by the user and the temperature of the energy storage device is higher than or equal to the temperature of the evaporator, using the first air door to close the energy storage device channel, using the second air door to close the evaporator channel, and using the third and fourth air doors to open the energy storage device channel, to guide air into the car through the air outlet device via the air inlet channel, the evaporator channel, the energy storage device channel, the heater core channel and the temperature-mixing channel; and
if the temperature of the energy storage device is lower than the temperature of the evaporator, using the first, third and fourth air doors to close the energy storage device channel, and opening the second air door, to guide air into the car through the air outlet device via the air inlet channel, the evaporator channel, the heater core channel, the temperature-mixing channel, and the air outlet device, wherein the temperature of the energy storage device 35 remains substantially unchanged in the closed energy storage device channel 16.

12. The control process according to claim 11, further including the step of using the first, third and fourth air doors to close the energy storage device channel 16 when the car and the air conditioner are turned off.

13. A control process executed in the fast cooling system according to claim 8, the control process including the steps of:
turning on the car and an air conditioner of the car;
using the control module to compare the temperatures from the temperature sensors;
if the temperature of the car is higher than the temperature set by the user and the temperature of the energy storage device is lower than the temperature of the evaporator, using the first, second and fourth air doors to close the evaporator channel, and opening the third air door, to guide air into the car through the air outlet device via the air inlet channel, the energy storage device channel, the heater core channel and the temperature-mixing channel;
if the temperature of the energy storage device is higher than the temperature of the evaporator, using the first air door to close the energy storage device channel, and using the fourth air door to open the energy storage device channel, to guide air into the car through the air outlet device via the air inlet channel, the evaporator channel, the energy storage device channel, the heater core channel, the temperature-mixing channel, and the air outlet device, wherein the temperature of the energy storage device 35 is being reduced because of cool air from the evaporator channel; and
if the temperature of the energy storage device is equal to the temperature of the evaporator, using the first, third and fourth air doors to close the energy storage device channel, and opening the second air door, to guide air into the car through the air outlet device via the air inlet channel, the evaporator channel, the heater core channel, the temperature-mixing channel, and the air outlet device.

14. The control process according to claim 13, further including the step of using the first, third and fourth air doors to close the energy storage device channel 16 when the car and the air conditioner are turned off.

15. An energy storage device for a fast cooling system for a car, the energy storage device including at least one energy storage pipe made of metal, having two closed ends, and filled with an energy storage material.

16. The energy storage device according to claim 15, wherein the energy storage material includes at least one material selected from the group consisting of water, cryogen-containing liquid, ionized liquid, a mixture of water with carbon nanotubes, and a mixture of water with a metal oxide.

17. The energy storage device according to claim 15, further including radiators 32 provided on the energy storage pipe.

18. The energy storage device according to claim 15, further including a refrigerant pipe 33 provided on and in direct contact with the energy storage pipe for connecting to an evaporator 152 of a refrigerant compression system 90 of a car.
